(19) United States
(12) Patent Application Publication
(10) Pub. No.: US 2004/0042873 A1
(43) Pub. Date: Mar. 4, 2004

(54) Bushing

(76) Inventor: Jedediah A. Burmahln, Valenica, CA (US)

Correspondence Address: BARNES & THORNBURG, P.O. BOX 2786, CHICAGO, IL, 60690-2786, US

(21) Appl. No.: 10/228,970

(22) Filed: Aug. 27, 2002

(51) Int. Cl. F16B 21/18

(52) U.S. Cl. 411/353

(57) ABSTRACT

Disclosed is a bushing for use with a fastener inside a bore. The bushing has a generally tubular body or wall which is shaped to provide a displaced portion to engage the work piece. The wall may have one or more slits to divide the wall into neighboring body portions to enhance the flexibility of the bushing. An annular perimeter flange extends from the body portion. Protruding ribs may be positioned along the interior of the tubular body adjacent to the perimeter flange extend to engage the fastener. The bushing is formed of a suitable flexible material to allow repeated flexing of the wall of the bushing to facilitate insertion and removal of the bushing from the bore.

### BACKGROUND

This disclosure is generally directed to a bushing which is designed to be reusable.

Bushings are used to retain fasteners such as bolts or screws within a bore. A degree of flexibility in the materials constituting the bushing help to prevent rattle or shaking and can accommodate variations in the width of a fastener or in the diameter of the bore which occur due to manufacturing tolerances.

One of the problems with currently available bushings is that after a fastener housed in a bushing is inserted into a bore, that same bushing generally cannot be removed and then reinserted. This inability to reuse the bushing is due to shearing that may occur during removal which can cause the bushing to deform.

One example of an industry having a need for a reusable bushing is the automobile industry. In particular, car seats are often attached to a rail which itself is connected the body of the car. The car seat communicates with the rail by means of a fastener being seated in a bore in the rail. It is this fastener that may need to be inserted and removed.

Such seats may need to be removed and reattached for a variety of reasons. A seat may need to be removed after a collision for repair or replacement. Also, car seats today may have features such as heated seats or electric adjustment. To reach components controlling or effecting these features, the seats may need to be removed. There is therefore a need for a reusable bushing that allows the fastener connecting the seat to the rails inside an automobile to be removed and then reinstalled without the need for a new bushing.

Briefly, and in accordance with the foregoing, disclosed is a bushing for the use and reuse in holding a fastener in position within a bore. The bushing has a body portion and an annular perimeter flange. In one embodiment, the body of the bushing has one or more neighboring wall sections separated by slits. The bushing is made from a suitable flexible material which allows the body of the bushing, which has a diameter generally greater than an inside diameter of a bore, to deform to produce an interference fit. A plurality of ribs may be provided along the inside edge of the bushing to provide for increased engagement between the bushing and the fastener.

In a second embodiment, a body portion is composed of a flexible outer wall an inner wall. The outer wall deforms when engaging the inner walls of a work-piece to produce an interference fit. The diameter of the inner wall is slightly smaller than the outside diameter of the fastener which provides a further tight fit of the bushing around the fastener.

Additional features will become apparent to those skilled in the art upon consideration of the following detailed description of drawings exemplifying the best mode as presently perceived.

### BRIEF DESCRIPTION OF THE DRAWINGS

The detailed description particularly refers to the accompanying figures in which:

FIG. 1 is a perspective view of a bushing;

FIG. 2 is a side elevational view thereof;

FIG. 3 is a cross-sectional view thereof taken along line 3-3 in FIG. 1;

FIG. 4 is a top plan view thereof;

FIG. 5 is a cross-sectional view of a fastener seated in the bushing;

FIG. 6 is a cross-sectional view of the fastener seated in the bushing, and the fastener and bushing engaging a bore in a work piece;

FIG. 7 is a perspective view of another embodiment of a bushing; and

FIG. 8 is a cross-sectional view of thereof taken along line 8-8 in FIG. 7;

### DETAILED DESCRIPTION OF THE DRAWINGS

While the present disclosure may be susceptible to embodiment in different forms, there is shown in the drawings, and herein will be described in detail, embodiments with the understanding that the present description is to be considered an example of the principles of the disclosure and is not intended to limit the disclosure to the details of construction and the arrangements of components set forth in the following description or illustrated in the drawings.

With reference to the figures, FIG. 1 shows a perspective view of a bushing 5. The bushing 5 has a wall 6 defining a generally tubular body 10. One or more slits 14 are provided in the wall 6 to divide the body 10 into neighboring wall body portions 8. The slits 14 divide the wall 6 starting from a first end 13 in a direction toward a second end 15, and continuing a portion of the distance between the first end 13 and the second end 15. An annular perimeter flange 12 extends generally perpendicularly from the second end 15 of the wall 6 of the body 10.

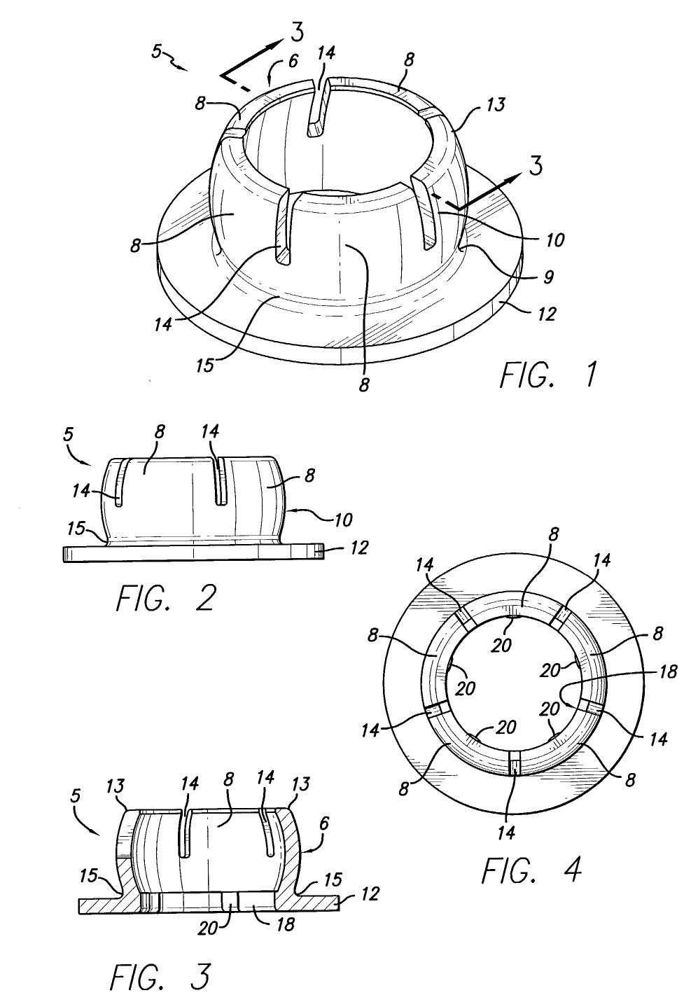

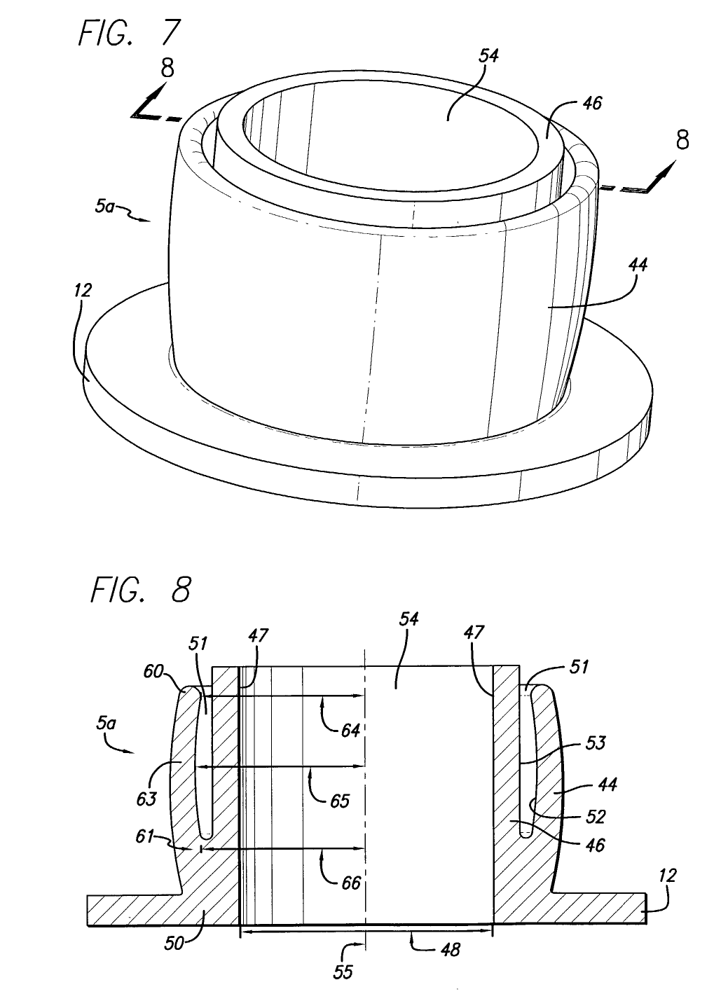

The bushing 5 is formed of a material that provides a degree of flexibility which may include but is not limited to metal or plastic. This flexibility is desired to allow a central portion 17 of the wall body portions 8 of the bushing 5 to flex inwardly when the bushing 5 is inserted into a bore 40 (see FIG. 6). The bushing 5 may also not include the slits 14, but the slits 14 are shown because they have been found to provide some degree of added flexibility. FIG. 2, shows a side elevational view of the bushing 5.

The slits 14 can be formed in the wall 6 either by process of cutting the wall 6 after the bushing 5 is formed or by forming the slits 14 in the wall during a forming process during which the bushing 5 is formed. In this regard, the bushing could be formed by molding plastic or metal to achieve the desired shape. As noted, the as formed bushing 5 could be formed with slits 14 or could be further processed by cutting or other operation to form the slits 14.

As shown in FIG. 3 and FIG. 4, an interior surface 18 of the wall body portion 8 of the bushing 5 may also include one or more protrusions or ribs 20 generally evenly spaced around the interior surface 18. The ribs 20 are generally evenly spaced around the interior surface in order to provide a centering function for effect on the bushing 5. Additionally, the ribs 20 are generally positioned on the interior surface 18 in the area proximate to the junction of the second end 15 of the wall 6 and the flange 12. This is generally an area which does not flex, as does the generally curved central portion 17 of the wall 6. These ribs 20 are also made of a flexible material which allows them to deform when a fastener is inserted into the interior 18 of the bushing 5. The ribs 20 are thus able to provide a degree of engagement which holds the fastener in place.

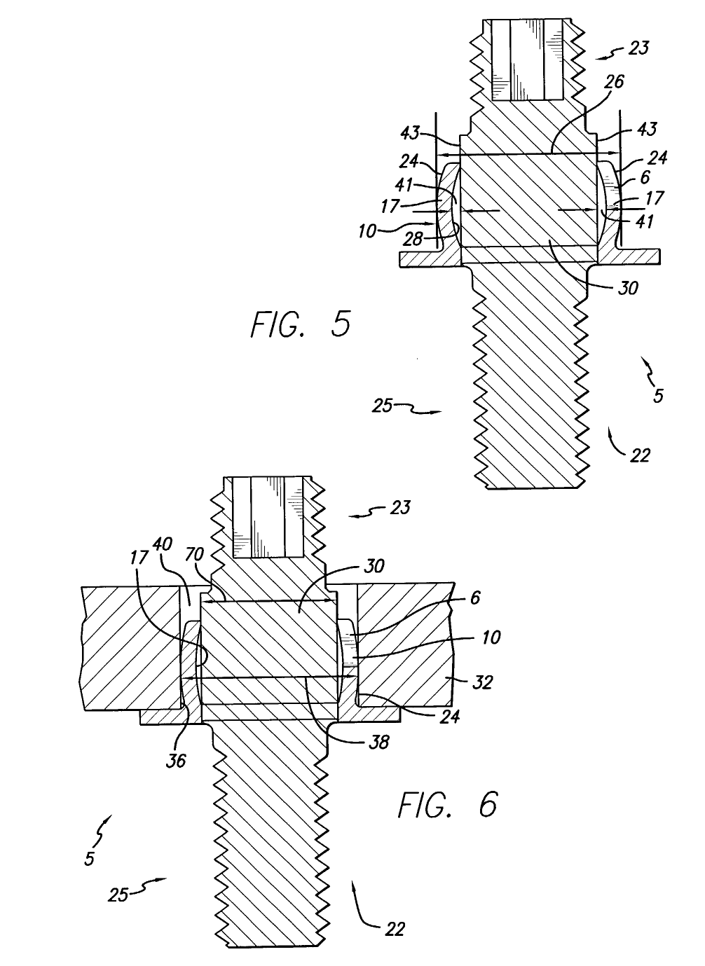

FIG. 5 shows the bushing 5 with a fastener 22 seated therein. As discussed above, the fastener 22 may be for example, a bolt, screw, rivet or other structure protruding from a car seat (not shown) which is insertable in a rail (not shown) attached the body of the car. As shown in FIGS. 5 and 6 a fastener 22, in this embodiment shown as a double-ended stud, is positioned in the bushing 5 with the body 10 abutting a shoulder or dowl portion 30. The dowl portion 30 might also be referred to as a stud shoulder. As shown in FIGS. 5 and 6, the fastener 22 has a first portion 23 and a second portion 25. The first portion 23 could be screwed into a seat and the second portion 25 could be bolted or screwed onto a rail. This arrangement may be reversed if the bushing 5 is oriented such that the flange 12 abuts the underside of a rail.

FIG. 6 shows the bushing 5 with the fastener 22 seated therein proximate to a work piece 32. A bore 40 is formed in the work piece 32 which as an inside diameter 38 defined by the distance between opposite sides of an interior surface 36. The tubular body 10 is shown in a deformed state. The deformed state of the tubular body 10 results from the inward flexion of the wall 6. The inward flexion of the wall 6 occurs as a result of an outside diameter 26 of the body 10 as shown in FIG. 5 being slightly larger than the inside diameter 38 of the bore 40 as shown in FIG. 6. As noted above, the body portion 10 of the bushing 5 being formed of a material which can be flexed to some degree. It should be noted that while the body 10 may generally have somewhat rigid characteristics, the material has been chosen to provide a degree of flexibility when the body 10 is inserted into the bore. For example, one material which might be used in the formation of the bushing 5 could be nylon.

Generally, as shown in FIGS. 1-6, the differential between the outside diameter 26 defined by outer surfaces 24 of the body 10 of the bushing 5 and the inside diameter 38 of the bore 40 is equal to or less than the sum of the dimensions defined by gaps 41. Gaps 41 are defined between opposite sides of the bushing 5 and fastener 22. For example, as shown in FIG. 5, the gaps 41 are defined between an outside surface 43 of the stud shoulder 30 and the inside surface 28 of the body 10 generally at the central portion 17 of the wall 6. The gaps 41 generally, can be no larger than the differential unless the material used to form the body 10 is, in itself, provides a degree of compressibility. In this deformed state, the wall 6 of the body 10 creates an outwardly directed force which cause an exterior surface 24 to impinge on the corresponding exterior surface 36 of the work-piece 32. This force helps provide an interference fit to retain the bushing 5 and the fastener 22 seated therein inside the bore 40. When so engaged, the bushing 5 acts to hold the fastener 22 in a captive position which reduces undesirable rattle or vibration and prevents the fastener 22 from sliding out.

The bushing 5 may also be constructed to be retained in the bore 40 when the fastener 22 is removed. Such a design may not include the ribs 20 along the interior 18 of the bushing 5. The work piece 32 may be fabricated with the bore 40 slightly larger or slightly smaller, with such variation within a specified tolerance. Similarly, fasteners 22 may be manufactured with slightly different diameters, still within a specified tolerance (e.g. plus or minus 0.005 centimeters). The bushing 5 helps to provide an interference fit by flexing to accommodate the variations in the dimensions of fasteners 22 and bores 40.

FIG. 7 shows another embodiment of the bushing 5a that has a generally curved outer wall 44 and a generally tubular, inner wall 46. As shown in FIG. 8, the inner wall 46 and outer wall 44 are joined in a merged portion 50 proximate to the flange 12. An annular slot 51 is defined between an interior surface 52 of the outer wall 44 and an outer surface 53 of the inner wall 46. The outer wall 44 provides a similar flexible deforming function as described herein above with regard to the wall 6 of the body 10 of the first embodiment shown and described above. The outer wall 44 is further defined by a first end 60 and a second end 61, and a central or displaced portion 63. The central or displaced portion 63 may tend toward or away from a central axis 55. The inner wall 46 defines a bore or passage 54 and a diameter 48 measured between the interior surfaces 47 of the inner wall 46. A dimension 64 between the central axis 55 and the first end 60 and a dimension 66 between the central axis 55 and the second end 61 is generally equal. The dimension 65 between the central axis 55 and central or displaced portion 63 may be greater than the dimensions 64, 66 as the outer wall 46 flexes to accommodate the fastener 22. The inner wall 46 is generally spaced equally from the central axis 55. The interior diameter 48 of the inner wall 46 is slightly smaller than or generally equal to diameter 70 of the fastener 22 (see FIGS. 5 and 6 for the fastener 22). This dimensional relationship facilitates an interference or snug fit of a fastener 22 in the bore 54 of the bushing 5a. The interference generally secures the bushing 5a on the fastener 22, generally in the shoulder area 30 to retain it in a desired position.

While preferred embodiments of the disclosure are shown and described, it is envisioned that those skilled in the art may devise various modifications and equivalents without departing from the spirit and scope of the disclosure as recited in the following claims.

What is claimed is:

1. A bushing having a generally tubular body comprising a wall generally defining the tubular body, the wall being defined by a first end and a second end with the wall generally extending therebetween, a central axis extending through the bushing and generally parallel with the wall, the first end and the second end generally spaced from the central axis, and a displaced portion of the wall being positioned away from the central axis by one of greater than or less than the dimensions by which the first end and second end are spaced from the central axis, whereby the displaced portion the bushing extends towards or away from the central axis relative to the first end and second end.

2. The bushing of claim 1, further comprising a generally annular flange extending from the second end of the wall, the flange generally extending outwardly generally perpendicular to the central axis of the bushing.

3. The bushing of claim 1, wherein the wall is divided into a plurality of wall body portions, each of the body portions generally spaced from a neighboring body portion by a slit.

4. The bushing of claim 1, wherein the tubular body portion is divided by at least one slit.

5. The bushing of claim 4, wherein the slit is oriented generally parallel to the central axis.

6. The bushing of claim 1, further comprising at least one rib positioned on an interior surface of the wall, the rib extending from the wall inwardly towards the central axis.

7. The bushing of claim 1, further comprising an inner wall positioned inwardly of the wall, the inner wall extending generally parallel to the central axis, an annular slot being defined between the inner wall and the wall providing space between an interior surface of the wall and outer surface of the inner wall.

8. A bushing for use with a fastener, the bushing comprising: means for biasing the bushing in engagement with a work piece; and means for retaining the bushing on at least a portion of the fastener.

9. The bushing of claim 8, further comprising means for limiting movement of the bushing while in the work piece.

10. The bushing of claim 9, further comprising multiple biasing means for facilitating flexing of the bushing to engage the work piece.

11. The bushing of claim 8, wherein the means for biasing the bushing includes a wall and a generally tubular structure defined along a central axis extending therethrough, the wall including a first end and a second end spaced from the central axis and a displaced portion having a dimension relative to the central axis which is one of greater than or less than to the dimensions by which the first end and second end are spaced from the central axis, at least one of the first end and second end providing means for retaining the bushing on at least a portion of the fastener.

12. The bushing of claim 9, in which the means for limiting movement is defined by a flange extending from the bushing.

13. The bushing of claim 11, further comprising dividing the wall with at least one slit for increasing the flexibility of the biasing means.

14. The bushing of claim 11, further comprising the wall being defined by a plurality of neighboring body portions defining slits therebetween.

15. A bushing for use with a fastener, the bushing including an inner wall and an outer wall defined generally along a central axis, the inner wall having a generally tubular construction defining a bore through which a fastener is inserted, the inner wall and outer wall are joined in a merged portion, the outer wall being spaced from the central axis a generally equal dimension, and a displaced portion of the wall spaced generally between the first end and the second end having a dimension which is greater than or less than the dimensions by which the first end and second end are spaced from the central axis.

16. The bushing of claim 15, further comprising a flange extending from the bushing proximate to the merged portion and extending generally perpendicularly outwardly from the bushing relative to the central axis.

17. The bushing of claim 15, wherein the wall is divided into a plurality of wall body portions, each of the wall body portions generally spaced from a neighboring wall body portion by a slit defined therebetween.

18. The bushing of claim 15, wherein the body portion is divided by at least one slit.

19. The bushing of claim 18, wherein the slit is oriented generally parallel to the central axis.

20. The bushing of claim 15, further comprising at least one rib positioned on the interior surface of the wall, the rib extending from the wall inwardly towards the central axis.

21. The bushing of claim 15, further comprising an inner wall positioned inwardly of the wall extending generally parallel to the central axis, an annular slot being defined between the inner wall and the wall providing space between an interior surface of the wall and the outer surface of the inner wall.
